(19) United States
(12) Patent Application Publication
(10) Pub. No.: US 2006/0068091 A1
(43) Pub. Date: Mar. 30, 2006

(54) Method for manufacturing functional film and method for manufacturing thin film transistor

(75) Inventor: Atsushi Denda, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/213,972

(22) Filed: Aug. 30, 2005

(30) Foreign Application Priority Data
Sep. 30, 2004 (JP) 2004-288694

(51) Int. Cl. B05D 3/02

(52) U.S. Cl. 427/226

(57) ABSTRACT

A method for manufacturing a functional film, including disposing a first ink on a substrate and disposing a second ink on the first ink that has been disposed, the first ink containing at least one of a metal and a metal oxide as a solute, the metal and the metal oxide having a melting point of 900 degrees and above in bulk, upon making the metal and the metal oxide to a particle of having a diameter of from 30 to 150 nm, the particle having a melting point of 255 degrees centigrade and above, and the second ink containing an organic metal salt as a solute.

### BACKGROUND OF THE INVENTION

1. Technical Field

The present invention relates to a method for manufacturing a functional film and a method for manufacturing a thin film transistor.

2. Related Art

A photolithographic method is used in the process for forming electrodes or wirings, etc., when thin film transistors (TFTs) are manufactured that serve as switching elements used in electro-optical devices such as liquid crystal devices, etc. Circuit patterns of a functional film are formed by the photolithographic method as following: the functional film is formed existing film forming methods such as spattering or CVD in advance; a photosensitive material called a resist is coated on a substrate; the circuit patterns are exposed and developed; and the functional film is etched corresponding to resist patterns. The forming and patterning of the functional thin film using the series of photolithography methods, however, have the following disadvantages: large-scale equipment such as vacuum devices and sophisticated processes are required in the film forming process and etching process; the efficiency in the use of material is nearly a few percent; almost all of materials have no choice but to be disposed; and not only high manufacturing cost, but also low productivity.

Alternatively, a method is proposed so that a pattern of the functional film (thin film pattern) is formed on a substrate by using a droplet discharge method (called an inkjet method) in which a functional liquid material is discharged from a liquid discharge head as a droplet. For example, the method is disclosed in Japanese Unexamined Patent Publication No. 2003-317945. In the method, an ink for thin film pattern is directly coated on the substrate as the pattern. The ink is a functional liquid in which a conductive fine particle such as a metal fine particle or the like is dispersed. Then, heat treatment and a laser irradiation are conducted so that the ink is converted into the conductive thin film pattern. The method has the following advantages: conventional film forming processes, photolithography processes, and etching processes are not required; processes are drastically simplified; less usage quantity of raw materials; and productivity is increased.

According to the technique disclosed in Japanese Unexamined Patent Publication No. 2003-317945, a bank is formed corresponding to a functional thin film pattern to be formed. Then, a functional liquid is discharged between banks. The liquid is dried so that the thin film pattern is achieved. Here, if a thin film transistor is formed by forming the thin film pattern using the inkjet method with a functional ink, the following problems often occur. The functional ink contains a metal fine particle (e.g. ITO or Ni, etc.), which has a high melting point (e.g. 1000 degrees centigrade and above) when the metal is bulk, and a little melting point drop when the metal is made to the fine particle, as a solute.

Particularly, in the manufacturing process of the amorphous silicon TFT, the firing temperature of the functional ink should be approximately 250 degrees centigrade and below in order to prevent hydrogen sintered in the amorphous silicon from a desorption. However, in the functional ink containing the high melting point metal fine particle as the solute, if the functional film is achieved by firing at a temperature of 250 degrees centigrade and below, no welding occurs and no sintering proceeds among the fine particles. This causes very poor flatness of the film surface and density in the film. As a result, no desired film characteristic can be achieved. In addition, this causes, for example, a breakdown voltage defect of an interlayer insulation film such as a gate insulation film, or a contact defect between the conductive films, and an adhesive strength defect with respect to the substrate (underlayer film), etc.

### SUMMARY

An advantage of the invention is to provide a method for manufacturing a functional film that has a good surface flatness and density, and can thoroughly secure a desired film characteristic regardless a firing temperature, i.e. even if the firing temperature is set at a low temperature, and a method for manufacturing a thin film transistor by the method for manufacturing a functional film.

According to an aspect of the invention, a method for manufacturing a functional film includes a step for disposing a first ink on a substrate, and a step for disposing a second ink on the first ink that has been disposed. The first ink contains a metal and/or a metal oxide as a solute. The metal and the metal oxide have a melting point of 900 degrees and above when they are in bulk. When the metal and the metal oxide are made to a particle having a diameter of from 30 to 150 nm, the particle has a melting point of 255 degrees centigrade and above. The second ink contains an organic metal salt as a solute.

According to the method, when the first ink containing a high melting point metal as the solute is fired to be a high melting point metal film (a first functional film), the achieved functional film has a good surface flatness and density, even if the firing temperature is set at a low temperature (e.g. approximately 250 degrees centigrade). This is because the second ink containing the organic metal salt as the solute is disposed on the first ink. The functional film of the aspect of the invention is achieved by forming an organic metal salt film (a second functional film) made of the organic metal salt on the high melting point metal film formed by firing at a low temperature. The decomposition temperature, at which the metal or metal oxide are produced, of the organic metal salt is relatively low temperature, so that a minute film can be produced by the firing. As a result, the functional film has a good surface flatness. In addition, the functional film achieved by firing the first ink is porous. By permeating the second ink to the porous film by an optimized coating quantity, high adhesiveness with respect to a substrate (underlayer film) can be achieved at the same time.

Each step is conducted so that the organic metal salt film made of the organic metal salt should be disposed on the surface layer side of the high melting point metal film. Specifically, the second ink may be disposed after drying or firing the first ink. The first ink and the second ink may be composed by solvents having no compatibility with each other. Then, both inks may be fired in a lump sum. If the first ink and second ink are blended so as to be fired at a lump sum, the rate of the organic metal salt content or coating quantity of each ink is set so that the weight of the metal produced after decomposing the organic metal salt in the second ink is definitely larger than the total metal weight of the fine particle contained in the first ink.

As for the metal and/or the metal oxide (high melting point metal and/or metal oxide) included in the first ink, any of nickel, manganese, titanium, tantalum, tungsten, molybdenum, tin oxide, indium-tin oxide, indium-zinc oxide, tin oxide including halogen, and oxides of gold, silver, and copper can be used. As for the organic metal salt included in the second ink, organic salts of the metals can be used. The use of these materials allows the above-described problems to be solved.

In addition, one in which a filler and a binder are contained in addition to the organic metal salt can be used as the second ink. In this case, this ink allows the surface flatness and density of the achieved functional film to be improved, and high adhesiveness with respect to a substrate (underlayer film) to be achieved.

Further, one in which a particle made of the metal having a diameter of from 30 to 150 nm is contained in addition to the organic metal salt can be used as the second ink. As for the ratio between the organic metal salt and the particle, it is preferable that the weight of the metal produced after decomposing the organic metal salt is larger than the total weight of the contained metal particles. This case also allows the surface flatness and density of the achieved functional film to be improved. If the second ink containing the metal particle is employed, the high melting point metal film can have good adhesiveness with respect to the organic metal salt film, and the substrate (lowerlayer film).

As for the method for disposing the first ink and the second ink, for example, a droplet discharge method using a droplet discharge device can be employed. Other than that, a slit coating method utilizing the capillary phenomenon also can be employed.

Next, according to another aspect of the invention, a method for manufacturing a thin film transistor includes a step for forming a conductive film by using the method for manufacturing a functional film. According to the method, the conductive film having good surface flatness and density can be formed. As a result, a designed film characteristic can be demonstrated. Consequently, the thin film transistor achieved by the manufacturing method of another aspect of the invention excels in reliability. A very few occurrence of a breakdown voltage defect of an interlayer insulation film on the conductive film, a contact defect between the conductive films, an adhesiveness strength defect with respect to a substrate (underlayer film), or the like is achieved.

### BRIEF DESCRIPTION OF THE DRAWINGS

The invention will be described with reference to the accompanying drawings, wherein like numbers refer to like elements, and wherein:

FIGS. 1A through 1C are sectional schematic views illustrating a wiring pattern forming process in an embodiment of the invention;

FIGS. 2A through 2C are sectional schematic views illustrating the wiring forming process following FIGS. 1A through 1C;

FIGS. 3A through 3C are sectional schematic views illustrating the wiring forming process following FIGS. 2A through 2C;

FIG. 4 is a schematic perspective view of a droplet discharge device;

FIG. 5 is a schematic view explaining a principle of discharging a liquid by a piezo method; and

FIG. 6 is a sectional schematic view explaining a slit coating method.

### DESCRIPTION OF THE EMBODIMENTS

Embodiments of the invention will be described below with reference to the drawings. It should be noted that in each drawing, a different scale is used for each layer and each part to present each layer and each part in recognizable size on the drawings.

First, an embodiment of a method for manufacturing a functional film of the invention will be described. In the following manufacturing method, a bank is formed so that a wiring pattern (functional film) is formed in a region surrounded by the bank by using a droplet discharge method with a droplet discharge device. Hereinafter, each of these processes is described in detail.

In the method for forming the wiring pattern (functional film) according to the embodiment, after disposing a first ink for wiring pattern on a substrate, a second ink for wiring pattern is disposed. The method is roughly composed of a HMDS film forming process, a bank forming process, a residue treatment process (lyophilic process), a lyophobic process, a first material disposing process, a first drying process, a second material disposing process, a second drying process, and a firing process. Hereinafter, each of these processes is described in detail.

HMDS Forming Process

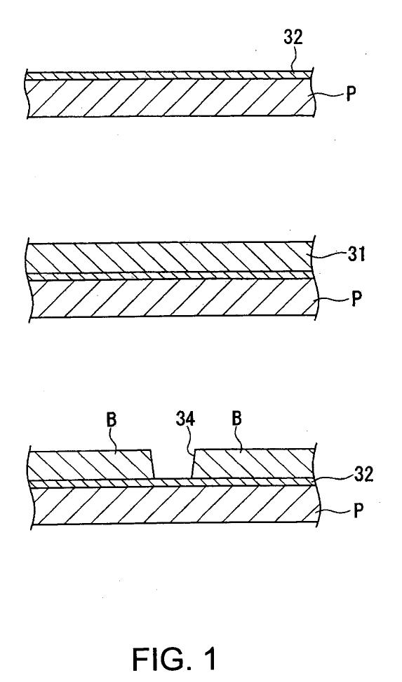

First, substrate P made of glass or the like is prepared. On the substrate P, a hexamethyldisilazane (HDMS) film 32 is formed as shown in FIG. 1A. The HDMS film 32 improves adhesiveness between the substrate P and an organic photosensitive material 31 (refer to FIG. 1B). The HDMS film 32 is, for example, formed by a method (HDMS treatment) in which HDMS is vaporized so as to be stuck on an object.

Bank Forming Process

The bank functions as a partition member. The bank can be formed by any methods such as a lithography method, printing, or the like. For example, in a case where the lithography method is used, the organic photosensitive material 31 is coated on the substrate P as shown in FIG. 1B by a desired height by using a given method such as spin coating, spray coating, roll coating, die coating, and dip-coating, etc. On the material 31, a resist layer is coated. Then, the resist is exposed and developed by using a mask aligned with a bank shape, so that the resist remains as aligned with the bank shape. Finally, the material of the bank excluding that under the mask is removed by etching. The bank (convex part) may be formed by two and above layers composed of the following layers: a lower-layer made of an inorganic or organic material having lyophilicity to a functional liquid; and an upper-layer made of an organic material having lyophobicity to the functional liquid.

Accordingly, bank B is formed so as to surround the periphery of a region (e.g. 10 μm width) to which the wiring pattern is formed, as shown in FIG. 1C. As a result, a region 34 (a region for forming wiring pattern) is formed.

Examples of the organic material forming the bank B may include a material originally having lyophobicity to a liquid material, and an insulation organic material as described later. The insulation organic material can be given lyophobicity by plasma treatment, and has good adhesiveness to an underlying substrate. Also, patterning on the material is easily performed by photolithography. For example, a polymer material such as acrylic resins, polyimide resins, olefin resins, and melamine resins, etc., can be used.

HMDS Film Patterning Process

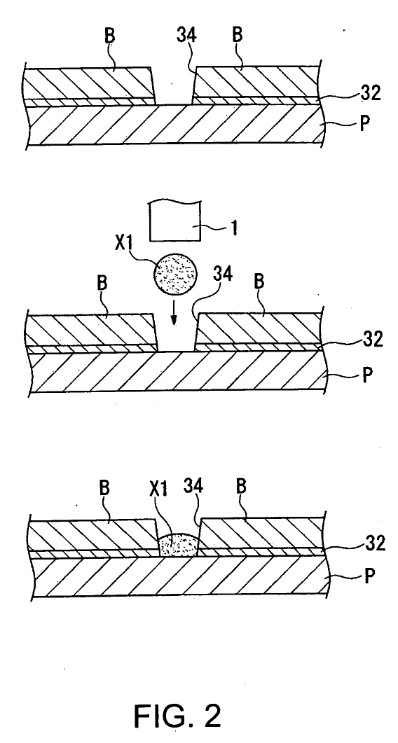

After forming the bank B on the substrate P, subsequently, the HMDS film 32 is patterned by etching the HMDS film 32 in the region 34 (the bottom of the region surrounded by the bank B) as shown in FIG. 2A. Specifically, the HMDS film is etched with, for example, 2.5% aqueous hydrofluoric acid by using the bank B as a mask to the substrate P on which the bank B is formed. As a result, the substrate P is exposed at the bottom of the region surrounded by the bank B.

Residue Treatment Process (Lyophilic Process)

Next, the residue treatment process is performed to the substrate P in order to remove a resist (organic material) residue in the region 34. The residue is produced when the bank is formed. As the residue treatment, ultraviolet rays (UV) irradiation treatment performing the residue treatment by irradiating ultraviolet rays, O₂ plasma treatment using oxygen as a treatment gas in the air atmosphere, or the like can be selected. In this case, the O₂ plasma treatment is conducted.

Specifically, oxygen in plasma state is irradiated to the substrate P from a plasma discharge electrode. As conditions of the O₂ plasma treatment, for example, plasma power is from 50 to 1000 W, an oxygen gas flow volume is from 50 to 100 ml/min, a substrate transportation velocity of the substrate P with respect to the plasma discharge electrode is from 0.5 to 10 mm/sec, and a substrate temperature is from 70 to 90 degrees centigrade. In a case where the substrate P is the glass substrate, its surface has lyophilicity to the material for forming wiring pattern. As shown in the embodiment, the lyophilicity of the substrate P exposed at the bottom of the region 34 can be more increased by performing the O₂ plasma treatment or ultraviolet rays irradiation treatment for the residue treatment.

Lyophobic Process

Subsequently, the lyophobic process is performed to the bank B to provide lyophobicity to the surface thereof. As the lyophobic process, for example, a plasma treatment method (CF₄ plasma treatment method) using tetrafluoromethane as a process gas in the atmosphere can be employed. As conditions of the CF₄ plasma treatment, for example, plasma power is from 50 to 1000 W, a tetrafluoromethane gas flow volume is from 50 to 100 ml/min, a substrate transportation velocity with respect to the plasma discharge electrode is from 0.5 to 1020 mm/sec, and a substrate temperature is from 70 to 90 degrees centigrade. The process gas is not limited to tetrafluoromethane (tetrafluorocarbon), but other fluorocarbon gases can also be used.

By performing such lyophobic process, a fluorine radical is introduced into the resin included in the bank B. As a result, the bank B has high lyophobicity to the substrate P. As for the acrylic resins and polyimide resins, etc., have a characteristic that pre-treatment by O₂ plasma eases them to be fluorinated (to have lyophobicity). Thus, while the O₂ plasma treatment as the lyophilic process may be performed before forming the bank B, the O₂ plasma treatment is preferably performed after forming the bank B. The lyophobic process on the bank B somewhat affects on the surface of the substrate P on which the lyophilic process has been performed. However, in a case where the substrate P is particularly made of glass or the like, the substrate P practically does not lose its lyophilicity, i.e. wettablity, since the fluorine radical can not be introduced to the substrate P by the lyophobic process. If the bank B is formed by a material having lyophobicity (e.g. a resin material having the fluorine radical), the lyophobic process may be omitted.

First Material Disposing Process

Next, as shown in FIG. 2B, a first ink for wiring pattern (functional liquid) is disposed on the substrate P exposed in the region 34 as a first material. Here, a droplet X1 is discharged by using a droplet discharge device equipped with a droplet discharge head 101. The ink included in the droplet X1 is the ink for wiring pattern, which contains a fine particle of a high melting point metal as a solute.

The droplet can be discharged by the following conditions as an example: the ink weight is 4 ng/dot; and the ink velocity (discharge velocity) is from 5 to 7 m/sec. The ambient atmosphere for discharging a droplet is preferably set at a temperature of 60 degrees centigrade and below, and a humidity of 80% and below. These conditions allow the discharge nozzle of the droplet discharge head 101 to stably discharge a droplet without clogging.

In the material disposing process, as shown in FIG. 2B, the ink X1 for wiring pattern is discharged from the droplet discharge head 101 as a droplet so as to dispose the droplet on the substrate P exposed in the region 34. In this case, since the substrate P exposed in the region 34 is surrounded by the bank B, the ink X1 for wiring pattern can be prevented from being spread over from a given position. In addition, the lyophobicity is given to the surface of the bank B. Since the surface of the bank B has the lyophobicity, even if a part of the ink X1 for wiring pattern is on the bank B, the ink X1 is repelled from the bank B due to the lyophobicity of the surface of the bank B, running down to the region 34. Further, the substrate P exposed in the region 34 has the lyophilicity. The lyophilicity allows the ink X1 for wiring pattern to easily spread on the substrate P exposed in the region 34. Accordingly, the ink X1 for wiring pattern can be uniformly disposed in an extended direction of the region 34 as shown in FIG. 2C.

The ink (functional liquid) for forming wiring pattern employed in the embodiment is composed of a dispersion liquid in which a conductive fine particle of a high melting point metal is dispersed in a dispersion medium. As for the conductive fine particle, for example, the fine particle of a metal and/or a metal oxide having a melting point of 900 degrees centigrade and above, and 255 degrees centigrade and above when they become a particle having a diameter of from 30 to 150 nm, are used. Specifically, any of nickel, manganese, titanium, tantalum, tungsten, molybdenum, indium oxide, tin oxide, indium-tin oxide, indium-zinc oxide, tin oxide including halogen, and oxides of gold, silver, and copper is used. These conductive fine particles also can be used by coating an organic material or the like on their surface in order to improve dispersibility.

Any dispersion medium that is capable of dispersing the conductive fine particles and does not cause an aggregation can be used. For example, other than water, alcohols such as methanol, ethanol, propanol, butanol, or the like, a hydro-carbon compounds such as n-heptane, n-octane, decane, dodecane, tetradecane, toluene, xylene, cymene, durene, indene, dipentene, tetrahydronaphthalene, decahydronaphthalene, cyclohexylbenzene or the like, an ether compounds such as ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, 1,2-dimethoxyethane, bis (2-methoxyethyl) ether, p-dioxane, or the like, and a polar compounds such as propylene carbonate, gamma-butyrolactone, N-methyl-2-pyrrolidone, dimethylformamide, dimethyl sulfoxide, cyclohexanone, or the like are exemplified. Water, alcohols, carbon hydride series compounds, and ether series compounds are preferable for the dispersion medium, water and carbon hydride series compounds are much preferred from the following points of view: a dispersion of the fine particle, a stability of the dispersion liquid, and an ease of the application for the droplet discharge method (inkjet method).

It is preferable that a surface tension of the dispersion liquid of the conductive fine particle is within a range of 0.02 N/m to 0.07 N/m. If the surface tension is below 0.02 N/m when the liquid is discharged by using the droplet discharge method, the wettability of the ink composition with respect to a discharge nozzle surface is increased, rendering it likely to cause a flight curve, while if the surface tension exceeds 0.07 N/m the meniscus shape at the tip of the nozzle is unstable, rendering the control of the discharge amount and discharge timing problematic. In order to adjust the surface tension, it is advisable to add a surface tension regulator of a fluorine based, silicone based, and nonionic, or the like, to the dispersion liquid, in a minute amount within the range that does not unduly lower the angle of contact with the substrate. The nonionic surface tension regulator enhances the wettability of a liquid with respect to a substrate, improves the leveling property of a film, and serves to prevent minute concavities and convexity of a film from being made. The surface tension regulator may include, if necessary, organic compounds such as alcohol, ether, ester, and ketone, etc.

The viscosity of the dispersion liquid is preferably not less than 1 mPa·s nand above than 50 mPa·s. When the liquid material is discharged by the inkjet method as a droplet, if the viscosity is below 1 mPa·s, the periphery part of the nozzle is easily contaminated due to the leakage of ink, while viscosity greater than 50 mPa·s results in a high frequency of clogging of the nozzle opening, not only rendering the smooth discharge of the droplet difficult but also reducing the discharge amount of the droplet.

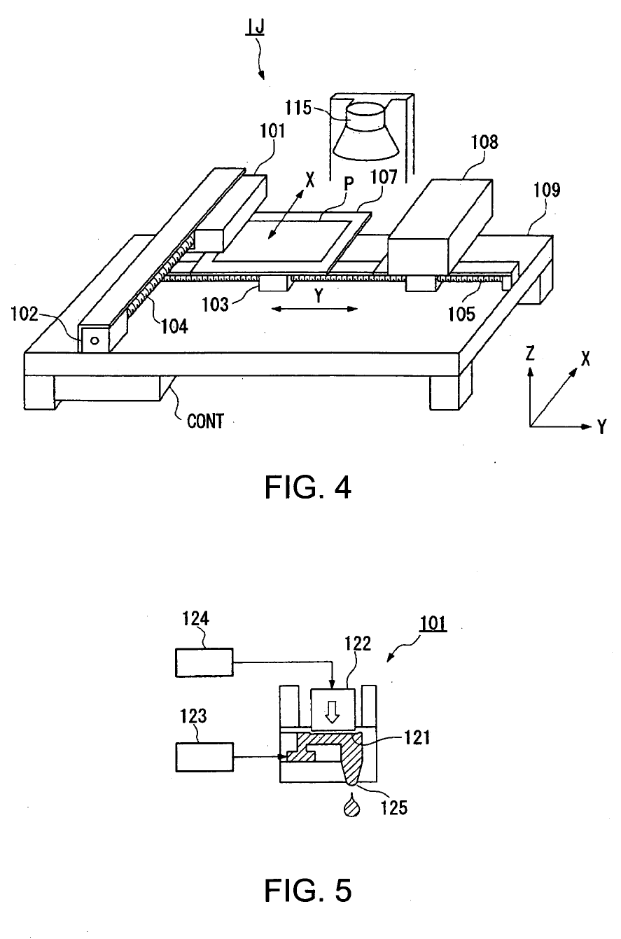

Here, a schematic structure of the droplet discharge device will be described. FIG. 4 is a perspective view illustrating a schematic structure of a droplet discharge device IJ. The droplet discharge device IJ includes the droplet discharge head 101, an X-axis direction drive axis 104, a Y-axis direction guide axis 105, a controller CONT, a stage 107, a cleaning mechanism 108, a base 109, and a heater 115.

The stage 107, which supports a substrate P to which the liquid material (ink for wiring pattern) is provided by the droplet discharge device IJ, includes a fixing mechanism (not shown) for fixing the substrate P to a reference position.

The droplet discharge head 101 is a multi-nozzle type droplet discharge head including a plurality of discharge nozzles. The longitudinal direction of the head 101 coincides with the Y-axis direction. The plurality of nozzles is disposed on a lower surface of the droplet discharge head 101 with a constant interval. The ink for wiring pattern containing the conductive fine particle is discharged from the droplet discharge head 101 to the substrate P supported by the stage 107.

An X-axis direction drive motor 102 is connected to the X-axis direction drive axis 104. The X-axis direction drive motor 102 is a stepping motor, etc., and rotates the X-axis direction drive axis 104 when a driving signal for the X-axis direction is supplied by the controller CONT. The X-axis direction axis 104 rotates so as to move the droplet discharge head 101 in the X-axis direction.

The Y-axis direction guide axis 105 is fixed so as not to move with respect to the base 109. The stage 107 is equipped with a Y-axis direction drive motor 103. The Y-axis direction drive motor 103 is a stepping motor, etc., and moves the stage 107 in the Y-axis direction when a driving signal for the Y-axis direction is supplied by the controller CONT.

The controller CONT supplies a voltage to the droplet discharge head 101 for controlling a droplet discharge. The controller CONT also supplies a drive pulse signal to the X-axis direction drive motor 102 for controlling the movement of the droplet discharge head 101 in the X-axis direction, and a drive pulse signal to the Y-axis direction drive motor 103 for controlling the movement of the stage 107 in the Y-axis direction.

The cleaning mechanism 108 cleans the droplet discharge head 101. The cleaning mechanism 108 is equipped with a drive motor (not shown) for the Y-axis direction. By driving the Y-axis direction drive motor, the cleaning mechanism is moved along the Y-axis direction guide axis 105. The movement of the cleaning mechanism 108 is also controlled by the controller CONT.

The heater 115, here, which is means to subject the substrate P under heat treatment by a lump annealing, evaporates and dries a solvent contained in the liquid material applied on the substrate P. Turning on and off of the heater 115 are also controlled by the controller CONT.

The droplet discharge device IJ discharges droplets to the substrate P from the plurality of discharge nozzles arranged on the lower surface of the droplet discharge head 101 while the droplet discharge head 101 and the stage 107 supporting the substrate P are relatively scanned.

FIG. 5 is a schematic view explaining a principal of discharging a liquid material by a piezo method.

In FIG. 5, a piezo element 122 is disposed adjacent to a liquid chamber 121 storing the liquid material (ink for wiring pattern, function liquid). The liquid material is supplied to the liquid chamber 121 through a liquid material supply system 123 including a material tank for storing the liquid material. The piezo element 122 is connected to a driving circuit 124. A voltage is applied to the piezo element 122 via the driving circuit 124 so as to deform the piezo element 122, so that the liquid chamber 121 is deformed to discharge the liquid material from a nozzle 125. In this case, a strain amount of the piezo element 122 is controlled by changing the value of the applied voltage. In addition, a strain velocity of the piezo element 122 is controlled by changing the frequency of the applied voltage. The droplet discharge by the piezo method has the advantage in that few influences is given to a composition of the material since no heat is applied to the material.

First Drying Process

After discharging the ink X1 for wiring patterning to the substrate P by a given amount, a drying process is conducted in order to remove the dispersion medium, if necessary. The drying process also can be conducted by lamp annealing in addition to a process conducted by using, for example, a typical hot plate or electric furnace for heating the substrate P. Examples of light sources for the lamp annealing are not particularly limited, but can include: infrared lamps, xenon lamps, YAG lasers, argon lasers, carbon dioxide lasers, and excimer lasers of XeF, XeCl, XeBr, KrF, KrCl, ArF, ArCl, or the like. Such light sources are typically used within the range of from 10 W to 5000 W, but in the embodiment, within the range of from 100 W to 1000 W is adequate.

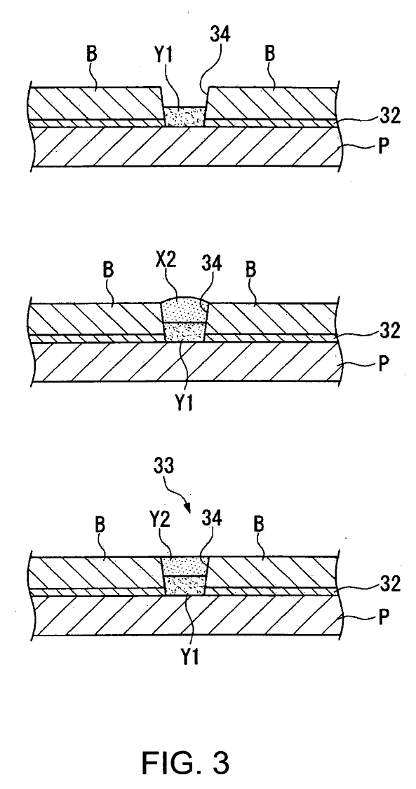

Accordingly, by the intermediate drying process, a first wiring pattern (first functional film) Y1 composed of the high melting point metal is formed on the substrate P in the region 34 as shown in FIG. 3A. In a case where the ink X1 for wiring patterning is not mixed with another type of the ink for wiring patterning even though the dispersion medium of the ink X1 for wiring patterning is not removed, the intermediate drying process may be omitted.

Second Material Disposing Process

Next, as shown in FIG. 3B, a second ink for wiring pattern (functional liquid) X2 is disposed on the first wiring pattern Y1 in the region 34 as a second material. Here, the droplet X2 is discharged by using the droplet discharge device IJ shown in FIG. 4 in the same way as that in the first material disposing process. The ink included in the droplet X2 is the ink for wiring pattern, which contains an organic salt of the high melting point metal as the solute.

As for the organic salt, the organic salts of the high temperature melting point metal can be exemplified as follows: chlorides, formates, acetate salts, acetylacetonate salts, ethylhexanoic salts, chelating agents, complexes, etc. Specifically, indium chloride, indium formate, indium acetate, acetylacetone indium, indium ethylhexanoate, tin chloride, tin formate, tin acetate, tin acetylacetonate, tin etylhexanoate, etc., can be exemplified. Any dispersion medium that is capable of dispersing the organic salt and does not cause an aggregation can be used. The solution used in the first material disposing process can arbitrarily be used.

The second ink X2 for wiring pattern can arbitrarily contained a filler or a binder. The silane coupling agents of the following series can be exemplified: vinyl, amino, epoxy, metacryloxy, mercapto, ketimine, cation, etc. In addition, titanate or alminate series coupling agent can be contained. Other than these, the binders such as cellulose series, siloxane, silicone oil, etc., may be contained. By containing these additives, the adhesiveness of the formed second wiring pattern with respect to the first wiring pattern Y1 and thus the substrate (underlayer film) can be improved. In addition, the second ink X2 for wiring pattern can contain a fine particle made of a metal having a grain diameter of approximately from 30 to 150 nm. In this case, the adhesiveness with respect to the first wiring pattern Y1 and thus the substrate (underlayer film) also can be improved.

Second Drying Process

After coating the ink X2 for wiring patterning, a drying process is conducted in order to remove the dispersion medium, if necessary. By conducting the drying process, the second ink X2 for wiring pattern forms a second wiring pattern Y2. The drying process can be conducted by the same method as that used for forming the first wiring pattern.

Accordingly, by the intermediate drying process, the second wiring pattern (second functional film) Y2 composed of the organic metal salt is formed on the first wiring pattern Y1 in the region 34 as shown in FIG. 3C.

Firing Process

The dried film after the disposing process is required so that a metal or a metal oxide is produced by thermally decomposing the organic metal salt as well as the dispersion medium is thoroughly removed in order to make a good electrical contact between the fine particles. Thus, heat treatment and/or light treatment is conducted to the substrate after the disposing process as the firing process. The heat treatment and/or the light treatment is usually conducted in the atmosphere. If necessary, they can also be conducted in an environment of inactive gas such as nitrogen, argon, helium, or the like. The processing temperature of the heat treatment and/or the light treatment is determined at an appropriate level, taking into account the boiling point (vapor pressure) of the dispersion medium, the type and pressure of the atmospheric gas, thermal behavior such as dispersibility or oxidizability, or the like, of the fine particle, thermal or chemical decomposition behavior of the organic metal salt, and further the heat resistance temperature of the base material, and a characteristic shift of the thin film transistor film, or the like.

As a result, a functional film 33 is formed as shown in FIG. 3C. In the embodiment, the second wiring pattern Y2 made of the organic metal salt is disposed on the first wiring pattern Y1 made of the high melting point metal. This allows the functional film 33 having high surface flatness, density, and adhesiveness with respect to the substrate (underlayer film) to be achieved regardless of the firing temperature.

Specifically, when the first wiring pattern Y1 was achieved by firing at a temperature of 250 degrees centigrade without forming the second wiring pattern Y2 made of the organic metal salt, the functional film included a lot of voids and had very poor surface flatness. In contrast, when the functional film was achieved by firing at a temperature 250 degrees centigrade after forming the second wiring pattern Y2 on the first wiring pattern Y1 as shown in the embodiment, the film had no void extending from the top surface to the inside of the film, and had good surface flatness.

More specifically, when the dispersion liquid of ITO fine particles coated on a glass substrate is fired at a temperature of 250 degrees centigrade as a comparative example, a void extending from the top surface to the inside of the film was observed. The roughness Rmax of the surface of the film was 150 nm and above. As another example, the dispersion liquid of the ITO fine particles was coated. Then, the dispersion liquid containing a cellulose series binder and an ITO organic salt was coated. Subsequently, they were fired at a temperature of 250 degrees centigrade. As a result, no void extending from the top surface to the inside of the film was observed. The roughness Rmax of the surface of the film was approximately 100 nm. As further example, the dispersion liquid of the ITO fine particles was coated. Then, the dispersion liquid containing an indium organic salt and a tin organic salt was coated. Subsequently, they were fired at a temperature of 250 degrees centigrade. As a result, no void extending from the top surface to the inside of the film was observed. The roughness Rmax of the surface of the film was approximately 50 nm and below.

The method described as above for manufacturing a functional film can be employed in the process for forming electrodes or wirings included in thin film transistors. Specifically, the method for manufacturing a functional film can be employed in the processes for forming gate electrodes, source electrodes or drain electrodes, and wirings such as source wirings or the like.

Particularly, the thin film transistor in which the amorphous silicon film is used as the active layer, requires the firing temperature of electrodes or wirings being approximately 250 degrees centigrade and below in order to prevent hydrogen sintered in the amorphous silicon from a desorption. Therefore, by employing the method for manufacturing a functional film when such thin film transistor is manufactured, the flatness of the film surface and the density of the film can be improved. As a result, a desired film characteristic is achieved, resulting in few breakdown voltage defect of an interlayer insulation film such as a gate insulation film or the like, or few contact defect between the conductive films.

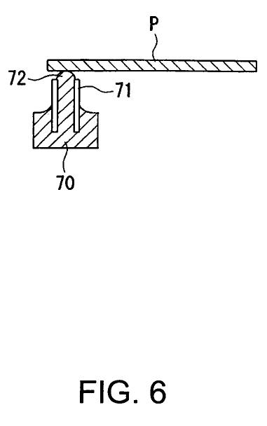

In the embodiment, the droplet discharge method using the droplet discharge device for disposing the droplet (functional liquid) is employed. However, the slit coating method as shown in FIG. 6 can be employed as any other methods. The slit coating method is a film forming method utilizing the capillary phenomenon. A slit 71 is inserted into a coating liquid 70. Then, the surface of the coating liquid is raised while keeping the condition in which the slit 71 is inserted into the coating liquid 70. As a result, a bulging liquid 72 is produced at the upper end of the slit 71. Upon contacting the substrate P to the bulging liquid 72, the substrate P is moved in a given direction while keeping a certain distance in the vertical direction. As a result, the coating liquid 70 can be coated on the surface of the substrate P.

In addition, in the embodiment, the first and second wiring patterns are fired at the same time. However, the second ink may be disposed after drying and firing the first ink. In this case, stability of the formed first wiring pattern with respect to the solvent (dispersion medium) in the second material disposing process can be improved.

1. A method for manufacturing a functional film, comprising:
disposing a first ink on a substrate; and
disposing a second ink on the first ink that has been disposed, wherein the first ink includes at least one of a metal and a metal oxide as a solute, the metal and the metal oxide having a melting point of 900 degrees and above in bulk, upon making the metal and the metal oxide to a particle of having a diameter of from 30 to 150 nm, the particle having a melting point of 255 degrees centigrade and above, and the second ink includes an organic metal salt as a solute.

2. The method for manufacturing a functional film according to claim 1 further comprising:
removing a solvent of the first ink so as to form a first functional film after disposing the first ink on the substrate: and
disposing the second ink on the first functional film that has been formed.

3. The method for manufacturing a functional film according to claim 1, at least one of the metal and the metal oxide being any of nickel, manganese, titanium, tantalum, tungsten, molybdenum, tin oxide, indium-tin oxide, indium-zinc oxide, tin oxide including halogen, and oxides of gold, silver, and copper.

4. The method for manufacturing a functional film according to claim 1, the organic metal salt being composed of an organic material containing the metal.

5. The method for manufacturing a functional film according to claim 1, the second ink containing a filler and a binder in addition to the organic metal salt.

6. The method for manufacturing a functional film according to claim 1, the second ink containing a particle made of the metal having a diameter of from 30 to 150 nm in addition to the organic metal salt.

7. The method for manufacturing a functional film according to claim 1, the second ink containing a particle made of the metal having a diameter of from 30 to 150 nm in addition to the organic metal salt, a weight of a metal produced after decomposing the organic metal salt being larger than a total weight of the particle contained in the second ink.

8. The method for manufacturing a functional film according to claim 1, the first ink and the second ink being disposed by a droplet discharge method using a droplet discharge device.

9. The method for manufacturing a functional film according to claim 1, the first ink and the second ink being disposed by a slit coating method utilizing a capillary phenomenon.

10. A method for manufacturing a thin film transistor, comprising forming a conductive film by using the method according to claim 1.

11. A method for manufacturing a thin film transistor, comprising forming a conductive film by using the method according to claim 2

12. A method for manufacturing a thin film transistor, comprising forming a conductive film by using the method according to claim 3.

13. A method for manufacturing a thin film transistor, comprising forming a conductive film by using the method according to claim 4.

14. A method for manufacturing a thin film transistor, comprising forming a conductive film by using the method according to claim 5.

15. A method for manufacturing a thin film transistor, comprising forming a conductive film by using the method according to claim 6.

16. A method for manufacturing a thin film transistor, comprising forming a conductive film by using the method according to claim 7.

17. A method for manufacturing a thin film transistor, comprising forming a conductive film by using the method according to claim 8.

18. A method for manufacturing a thin film transistor, comprising forming a conductive film by using the method according to claim 9.
